(19) United States
(12) Patent Application Publication
(10) Pub. No.: US 2015/0301718 A1
(43) Pub. Date: Oct. 22, 2015

(54) METHODS, SYSTEMS, AND MEDIA FOR PRESENTING MUSIC ITEMS RELATING TO MEDIA CONTENT

(71) Applicant: Google Inc., Mountain View, CA (US)

(72) Inventors: Ingrid McAulay Trollope, London (GB); Yaroslav Volovich, Cambridge (GB); Ant Oztaskent, Sutton (GB)

(21) Appl. No.: 14/256,547

(22) Filed: Apr. 18, 2014

(51) Int. Cl. G06F 3/0484

(52) U.S. Cl. CPC G06F 3/04842

(57) ABSTRACT

Methods, systems, and media for presenting music items relating to media content are provided. In accordance with some implementations, methods for presenting music items relating to media content are provided, the methods comprising: detecting a plurality of music segments of the media content item that include music content; identifying a plurality of pieces of music played in the plurality of music segments; generating, using a hardware processor, a playlist including information relating to the plurality of pieces of music; causing the playlist to be presented to a user; receiving a user selection of a portion of the playlist corresponding to a piece of music played in a first music segment of the plurality of music segments; and causing information relating to a plurality music items that match the first music segment to be presented in response to receiving the user selection.

### TECHNICAL FIELD

The disclosed subject matter relates to methods, systems, and media for presenting music items relating to media content.

### BACKGROUND

While watching media content (e.g., a television program, movie, etc.), a viewer is often interested in music content relating to the media content. For example, the viewer may want to review information relating to a piece of music (e.g., a song) played in the media content. As another example, the viewer may want to access, share, and/or purchase a music item (e.g., an audio clip, a video clip, etc.) containing a piece of music as it is played in the media content and/or by another artist.

In order to search for music content relating to the media content using a conventional search engine, the viewer may have to compose a search query including search terms associated with a particular piece of music played in the media content and may have to click through search results to find a Web page including information about the piece of music. This can be a time consuming and frustrating procedure for the viewer, especially when the viewer is unaware of the search terms (e.g., a title of a song) that may lead to the piece of music that the user is looking for. Additionally, the viewer may have to conduct multiple searches to review information relating to multiple pieces of music played in the media content.

Therefore, new mechanisms for presenting music items relating to media content are desirable.

### SUMMARY

In accordance with some implementations of the disclosed subject matter, methods, systems, and media for presenting music items relating to media content are provided.

In accordance with some implementations of the disclosed subject matter, methods for presenting music items relating to media content are provided, the methods comprising: detecting a plurality of music segments of the media content item that include music content; identifying a plurality of pieces of music played in the plurality of music segments; generating, using a hardware processor, a playlist including information relating to the plurality of pieces of music; causing the playlist to be presented to a user; receiving a user selection of a portion of the playlist corresponding to a piece of music played in a first music segment of the plurality of music segments; and causing information relating to a plurality music items that match the first music segment to be presented in response to receiving the user selection.

In accordance with some implementations of the disclosed subject matter, systems for presenting music items relating to media content are provided, the systems comprising: at least one hardware processor that is configured to: detect a plurality of music segments of the media content item that include music content; identify a plurality of pieces of music played in the plurality of music segments; generate a playlist including information relating to the plurality of pieces of music; cause the playlist to be presented to a user; receive a user selection of a portion of the playlist corresponding to a piece of music played in a first music segment of the plurality of music segments; and cause information relating to a plurality music items that match the first music segment to be presented in response to receiving the user selection.

In accordance with some implementations of the disclosed subject matter, non-transitory computer-readable media containing computer executable instructions that, when executed by a processor, cause the processor to perform a method for presenting music items relating to media content are provided. In some implementations, the method comprises: detecting a plurality of music segments of the media content item that include music content; identifying a plurality of pieces of music played in the plurality of music segments; generating, using a hardware processor, a playlist including information relating to the plurality of pieces of music; causing the playlist to be presented to a user; receiving a user selection of a portion of the playlist corresponding to a piece of music played in a first music segment of the plurality of music segments; and causing information relating to a plurality music items that match the first music segment to be presented in response to receiving the user selection.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows a generalized block diagram of an example of a system for presenting music items relating to media content in accordance with some implementations of the disclosed subject matter.

FIG. 2 shows an example of hardware that can be used in a server, a digital entertainment system, and/or a mobile device in accordance with some implementations of the disclosed subject matter.

FIG. 3 shows a flow chart of an example of a process for presenting music items relating to media content in accordance with some implementations of the disclosed subject matter.

FIG. 4 shows a flow chart of an example of a process for generating a playlist of music content relating to a media content item in accordance with some implementations of the disclosed subject matter.

FIG. 5 shows a flow chart of an example of a process for identifying a music item that matches a portion of a media content item in accordance with some implementations of the disclosed subject matter.

### DETAILED DESCRIPTION

In accordance with various implementations, as described in more detail below, mechanisms, which can include systems, methods, and computer-readable media, for presenting music items relating to media content are provided.

The mechanisms can be implemented with respect to any suitable media content. For example, media content can include any suitable type(s) of content, such as one or more of audio content, video content, text, graphics, multimedia content, captioning content, and/or any other suitable content. As another example, media content may be provided by any suitable source, such as a television provider, a video hosting and/or streaming service, a video recorder, and/or any other suitable content provider. As yet another example, media content may have any suitable format, such as one or more of JPEG, H.264, MPEG-4 AVC, MPEG-7, MP4, MP3, ASCII codes, and/or any other suitable format.

In some implementations, a music item can contain any suitable music content, such as one or more pieces of instrumental music, background music, songs, and/or any other suitable music content. In some implementations, a music item can include any suitable media content, such as audio content, video content, and/or any other suitable media content. In some implementations, a music item can include one or more audio files, video files, multimedia files, and/or any other suitable media files and can have any suitable format, such as MP3, WAV, WMA, H.264, MPEG-4 AVC, MPEG-7, MP4, and/or any other suitable media format.

These mechanisms can perform a variety of functions. For example, the mechanisms can present a user with a complete playlist of music content relating to a media content item (e.g., a television program, movie, recorded program, musical, and/or any other suitable media content item) prior to, during, and/or after presentation of the media content item. In some implementations, the playlist can include any suitable information relating to each piece of music that is played in association with the media content item. In some implementations, a piece of music played in association with the media content item can be a song, instrumental music, background music, and/or any other suitable music content that is played in one or more portions of the media content item (e.g., video scenes, opening credits, closing credits, commercial breaks, montages of footages, and/or any other suitable portion of the media content item).

As another example, the mechanisms can prompt a user to share, purchase, consume, and/or take any other suitable action on music items relating to a media content item by presenting information relating to the music items (e.g., a link to one or more of the music items) along with a playlist of music content played in the media content item. In some implementations, in response to receiving a user selection of a portion of the playlist corresponding to a piece of music played in the media content item and/or music items relating to the piece of music, the mechanisms can present the user with information relating to one or more music items relating to the piece of music (e.g., by rendering a Web page that includes such information and/or allow a user to consume, purchase, and/or share the music items). In some implementations, a music item relating to a given piece of music (e.g., a song) played in the media content item can include an original soundtrack of the piece of music that is played in the media content item, a soundtrack of the piece of music performed by a different artist, a soundtrack of the piece of music and/or a different piece of music that conveys a sentiment that is conveyed by the media content item, and/or any other suitable audio and/or video content that can be regarded as a match to the piece of music.

In some implementations, the mechanisms can receive an audio sample corresponding to a media content item and can then identify the media content item based on an audio fingerprint of the audio sample. For example, the mechanisms can compare the audio fingerprint against reference audio fingerprints that are stored and indexed by media content item. In some implementations, upon identifying a matching reference audio fingerprint, the mechanisms can identify a media content item associated with the matching reference audio fingerprint as the media content item associated with the audio sample.

In some implementations, the mechanisms can retrieve an audio signal associated with the media content item and identify one or more segments of the audio signal that include music content. For example, the mechanisms can divide the audio signal associated with the media content item into multiple segments (e.g., audio scenes) using any suitable audio segmentation technique. The mechanisms can then classify each of the segments into a class, such as “silence,” “speech,” “music,” “song,” “speech with music background,” “noise,” and/or any other suitable class. In some implementations, the mechanisms can identify a segment of the audio signal as a segment including music content when the segment of the audio signal is classified as “music,” “song,” “speech with music background,” and/or any other suitable class corresponding to an audio segment including music content. In some implementations, the mechanisms can identify one or more portions of the media content item that correspond to the identified audio segments as being music segments of the media content item.

In some implementations, the mechanisms can search for music items that match the music segments of the media content item. For example, the mechanisms can identify a music item as a match to a given music segment of the media content item when the music item and the music segment contain matching music content (e.g., a song, a piece of music, and/or any other suitable music content performed by the same artist and/or difference artists), matching audio content, matching video content, and/or any other suitable matching content. Additionally or alternatively, the music item and the music segment can be associated with matching sentiment indicators (e.g., “happy,” “sad” “exciting,” “neutral,” and/or any other suitable sentiment).

In some implementations, the mechanisms can generate a playlist of music content corresponding to the media content item. In some implementations, the playlist can include any suitable information relating to multiple pieces of music (e.g., songs, instrumental music, background music, and/or any other suitable music content) that are played in the media content item. Additionally, the playlist can include information relating to music items that match one or more of the pieces of music.

In some implementations, the playlist can be automatically presented when the media content item has ended. In some implementations, the mechanisms can present the playlist to a user responsive to a search query for music content relating to the media content item, such as a search query including one or more search terms corresponding to the media content item (e.g., a title) and one or more search terms indicative of the user's desire to search for music content relating to the media content item (e.g., “music,” “soundtrack,” and/or any other suitable search term).

In some implementations, the mechanisms can present a user with a list of media content items in which a particular piece of music is played in response to a search query for media content items relating to the piece of music. For example, such a search query may include one or more search terms corresponding to the piece of music (e.g., a title of the piece of music) and one or more search terms indicative of the user's desire to search for media content items relating to the piece of music (e.g., “movies,” “musical,” “programs,” and/or any other suitable search term indicative of such a desire).

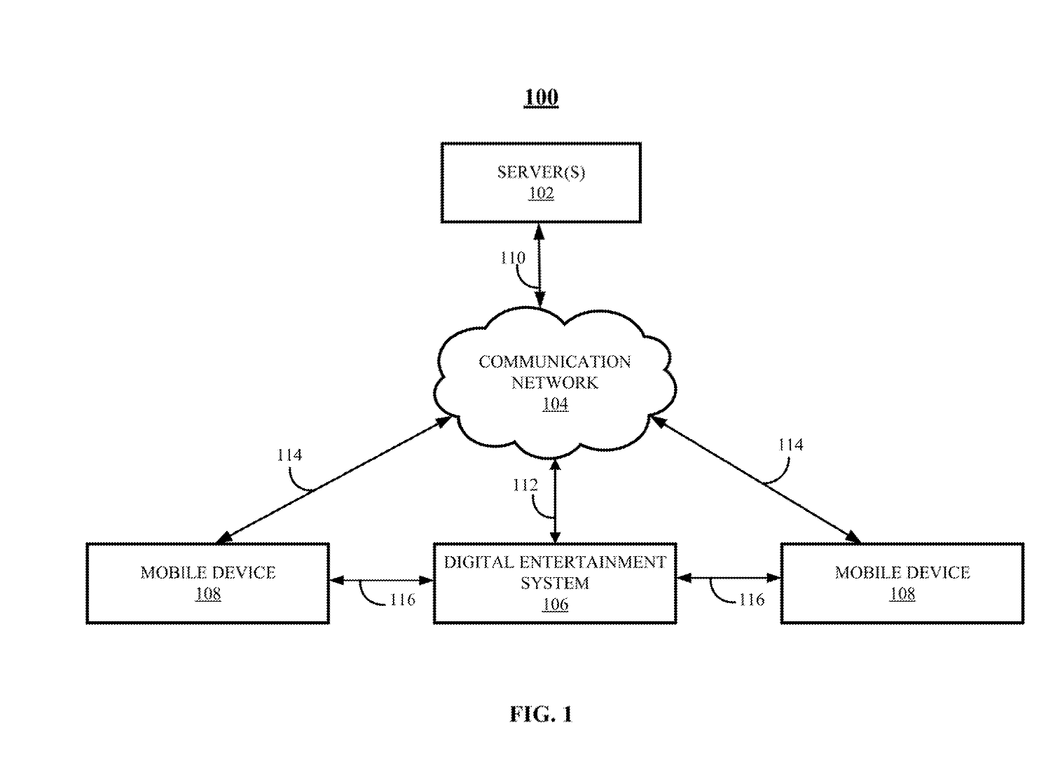

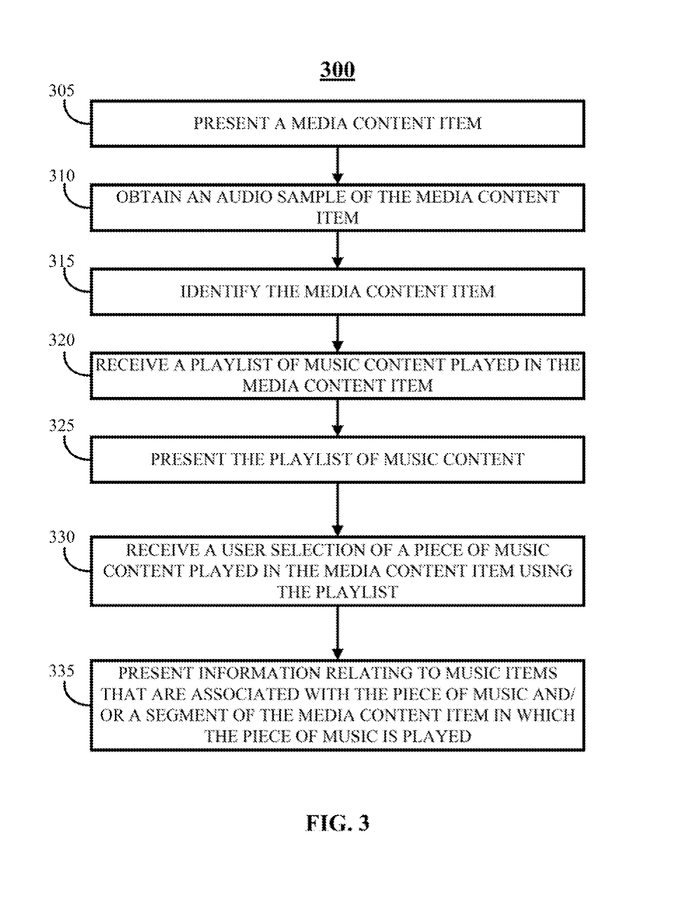

Turning to FIG. 1, a generalized block diagram of an example 100 of a system for presenting music items relating to media content is shown in accordance with some implementations of the disclosed subject matter. As illustrated, system 100 can include one or more servers 102, a communication network 104, a digital entertainment system 106, one or more mobile devices 108, communication links 110, 112, 114, and 116, and/or any other suitable components. In some implementations, one or more suitable portions of processes 300, 400, and 500 as illustrated in FIGS. 3-5 can be implemented in one or more components of system 100. For example, one or more suitable portions of processes 300, 400, and 500 can run on one or more of server(s) 102, digital entertainment system 106, and mobile device(s) 108 of system 100.

Server(s) 102 can include any suitable device that is capable of searching for music items relating to media content, performing video matching, audio matching, lyrics matching, and/or sentiment matching analysis on media content, generating playlists of music content relating to media content items, and/or performing any other suitable functions, such as a hardware processor, a computer, a data processing device, or a combination of such devices.

Digital entertainment system 106 can include any suitable device that is capable of receiving, converting, processing, rendering, and/or transmitting media content, generating, receiving, processing, transmitting, and/or presenting playlists of music content relating to media content items, and/or performing any other suitable functions. For example, digital entertainment system 106 can include a set-top box, a digital media receiver, a DVD player, a BLU-RAY player, a game console, a desktop computer, a laptop computer, a tablet computer, a mobile phone, and/or any other suitable device, and/or any other suitable combination of the same.

Mobile device(s) 108 can include any suitable device that is capable of receiving user inputs, generating and/or presenting playlists of music content relating to music content items, such as a mobile phone, a tablet computer, a laptop computer, a desktop computer, a personal data assistant (PDA), a portable email device, and/or any other suitable device.

In some implementations, each of server(s) 102, digital entertainment system 106, and mobile device(s) 108 can be implemented as a stand-alone device or integrated with other components of system 100.

Communication network 104 can be any suitable computer network such as the Internet, an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), a satellite network, a mobile phone network, a mobile data network, a cable network, a telephone network, a fiber optic network, and/or any other suitable communication network, or any combination of any of such networks.

In some implementations, server(s) 102, digital entertainment system 106, and mobile device(s) 108 can be connected to communication network 104 through communication links 110, 112, and 114, respectively. In some implementations, digital entertainment system 106 can be connected to mobile device(s) 108 through communication link 116. In some implementations, communication links 110, 112, 114, and 116 can be any suitable communication links, such as network links, dial-up links, wireless links, hard-wired links, any other suitable communication links, or a combination of such links.

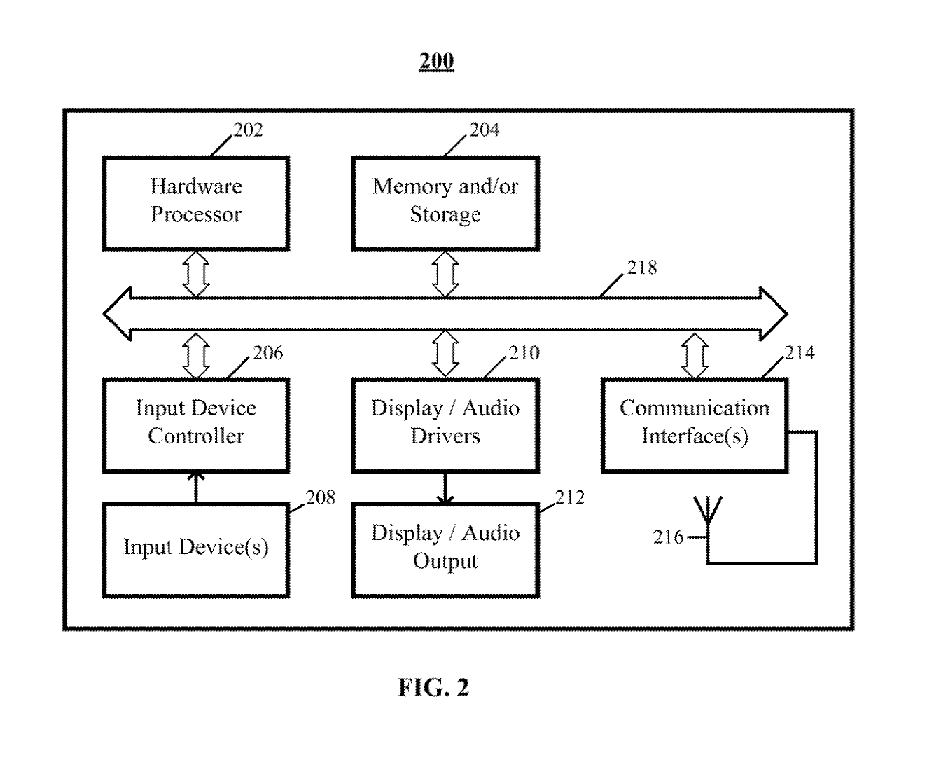

Each of server(s) 102, digital entertainment system 106, and mobile device(s) 108 can include and/or be any of a general purpose device such as a computer or a special purpose device such as a client, a server, and/or any other suitable device. Any such general purpose computer or special purpose computer can include any suitable hardware. For example, as illustrated in example hardware 200 of FIG. 2, such hardware can include a hardware processor 202, memory and/or storage 204, an input device controller 206, an input device 208, display/audio drivers 210, display and audio output circuitry 212, communication interface(s) 214, an antenna 216, and a bus 218.

Hardware processor 202 can include any suitable hardware processor, such as a microprocessor, a micro-controller, digital signal processor, dedicated logic, and/or any other suitable circuitry for controlling the functioning of a general purpose computer or special purpose computer in some implementations.

Memory and/or storage 204 can be any suitable memory and/or storage for storing programs, data, media content, and/or any other suitable content in some implementations. For example, memory and/or storage 204 can include random access memory, read only memory, flash memory, hard disk storage, optical media, and/or any other suitable storage device.

Input device controller 206 can be any suitable circuitry for controlling and receiving input from one or more input devices 208 in some implementations. For example, input device controller 206 can be circuitry for receiving input from a touch screen, from one or more buttons, from a voice recognition circuit, from a microphone, from a camera, from an optical sensor, from an accelerometer, from a temperature sensor, from a near field sensor, and/or any other suitable circuitry for receiving user input.

Display/audio drivers 210 can be any suitable circuitry for controlling and driving output to one or more display and audio output circuitries 212 in some implementations. For example, display/audio drivers 210 can be circuitry for driving an LCD display, a speaker, an LED, and/or any other display/audio device.

Communication interface(s) 214 can be any suitable circuitry for interfacing with one or more communication networks, such as communication network 104 in some implementations. For example, interface(s) 214 can include network interface card circuitry, wireless communication circuitry, and/or any other suitable circuitry for interfacing with one or more communication networks.

Antenna 216 can be any suitable one or more antennas for wirelessly communicating with a communication network in some implementations. In some implementations, antenna 216 can be omitted when not needed.

Bus 218 can be any suitable mechanism for communicating between two or more of components 202, 204, 206, 210, and 214 in some implementations.

Any other suitable components can be included in hardware 200 in accordance with some implementations.

In some implementations, any suitable computer readable media can be used for storing instructions for performing the processes described herein. For example, in some implementations, computer readable media can be transitory or non-transitory. For example, non-transitory computer readable media can include media such as magnetic media (such as hard disks, floppy disks, and/or any other suitable media), optical media (such as compact discs, digital video discs, Blu-ray discs, and/or any other suitable optical media), semiconductor media (such as flash memory, electrically programmable read only memory (EPROM), electrically erasable programmable read only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Turning to FIG. 3, a flow chart of an example 300 of a process for presenting music items relating to media content is shown in accordance with some implementations of the disclosed subject matter. In some implementations, one or more portions of process 300 can be implemented by one or more hardware processors, such as a hardware processor of a digital entertainment system 106 and/or a mobile device 108 of FIG. 1.

As illustrated, process 300 can start by presenting a media content item at 305. In some implementations, the media content item can include any suitable media content and can be provided by any suitable source. For example, the media content item can be a program broadcast by a television provider, a recorded video program, an on-demand program, a streaming program provided by a video streaming and/or hosting service, and/or any other suitable media content. In some implementations, the media content item can be presented using any suitable device such as a digital entertainment system as described above in connection with FIGS. 1 and 2.

At 310, process 300 can obtain an audio sample of the media content item. The audio sample can be obtained in any suitable manner. For example, process 300 can activate an audio input device (e.g., a microphone) that is configured to capture audio data from its surroundings and can instruct the audio input device to capture and record the audio sample or any other suitable audio data associated with the media content item. As another example, process 300 can record the video and/or audio output of the digital entertainment system and can then generate an audio sample responsive to the video and/or audio output. In some implementations, process 300 can extract digital data that can be used to identify the media content item from the audio sample and/or any other suitable signal representative of the media content item.

It should be noted that, prior to receiving audio samples or any other audio data using an audio input device, process 300 can provide a user (e.g., a user of a service provided by the mechanisms described herein, an author, a copyright holder, an artist, a music provider, and/or any other suitable user that can assert a legal right with respect to a piece of music played in the media content item, and/or any other suitable user) with an opportunity to provide a consent or authorization to perform actions, such as activating an audio input device, obtaining audio samples and/or audio data, and/or transmitting audio samples and/or audio data. For example, upon loading an application on a digital entertainment system and/or a mobile device, such as a television device or a media playback device, the application can prompt the user to provide authorization for activating an audio input device, collecting audio samples and/or audio data, transmitting audio samples and/or audio data, and/or performing any other suitable action. In a more particular example, in response to downloading the application and loading the application on a digital entertainment system and/or a mobile device, the user can be prompted with a message that requests (or requires) that the user provide consent prior to performing these actions. Additionally or alternatively, in response to installing the application, the user can be prompted with a permission message that requests (or requires) that the user provide content prior to collecting an audio sample and/or audio data and/or transmitting information relating to the audio sample.

At 315, process 300 can identify the media content item. In some implementations, the media content item can be identified using any suitable identifying information relating to the media content item, such as a content identifier (e.g., a program identifier, a uniform resource identifier (URI), and/or any other suitable identifier that can be used to identify the media content item), a title, a description, a channel number, a start time, an end time, a series number, an episode number, and/or any other suitable information that can be used to identify the media content item.

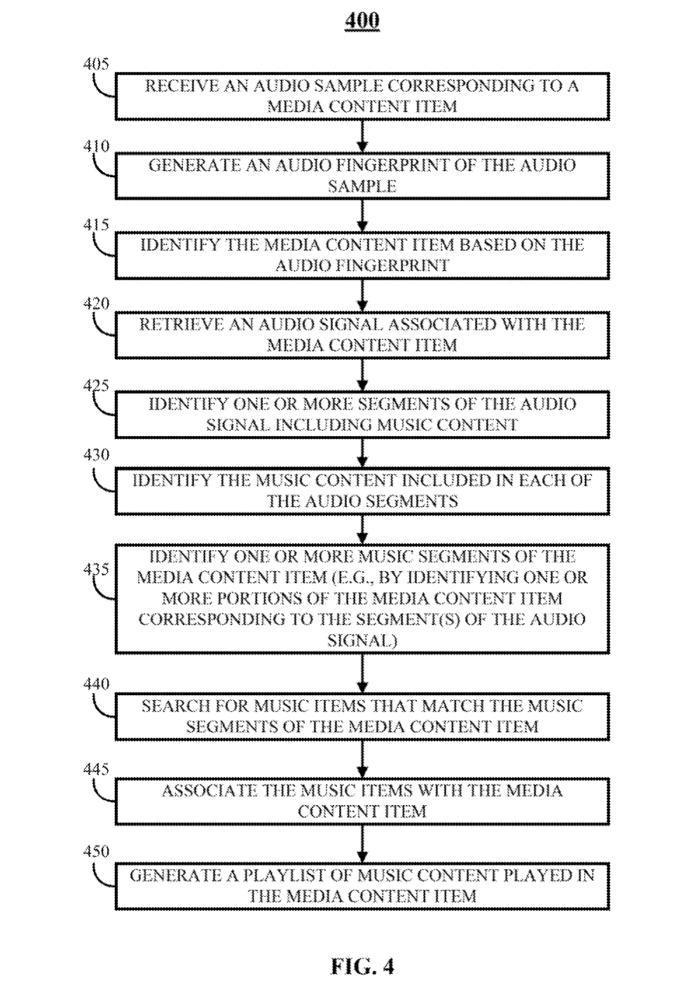

In some implementations, the identifying information relating to the media content item can be obtained in any suitable manner. For example, process 300 can query a server for identifying information relating to the media content item. In a more particular example, process 300 can transmit the audio sample and/or an audio fingerprint generated from the audio sample to the server. The server can then identify a media content item corresponding to the audio sample by comparing the generated audio fingerprint to multiple reference audio fingerprints that are stored in association with multiple media content items (e.g., steps 405-415 of FIG. 4).

As another example, process 300 can query a digital entertainment system (e.g., a digital entertainment system 106 of FIG. 1), a mobile device (e.g., a mobile device 108 of FIG. 1), and/or any other suitable device that is presenting the media content item for identifying information relating to the media content item, such as a channel that the digital entertainment system is tuned to, a URL through which the media content is being streamed, and/or any other suitable information that can be used to identify the media content item.

At 320, process 300 can receive a playlist of music content played in the media content item. In some implementations, the playlist can include a list of music content played in the media content item, such as songs, instrumental music, background music, and/or any other suitable music content played in a segment of the media content item. In some implementations, as described in connection with FIG. 4, the playlist can be generated using process 400.

In some implementations, the playlist can include any suitable information relating to a given piece of music played in the media content item. For example, the playlist can include a start time and/or an end time in the media content item corresponding to a segment of the media content item in which the piece of music is played. As another example, the playlist can include a title, an artist, a link to a music item including the piece of music, a music provider that provides music items including the piece of music, and/or any other suitable information relating to the piece of music.

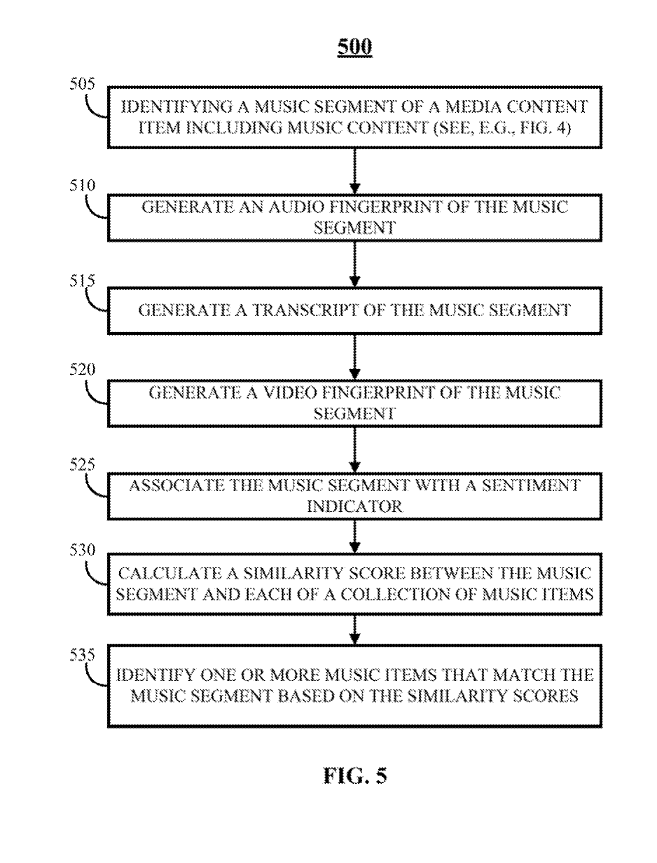

As yet another example, the playlist can include any suitable information relating to one or more music items that match the piece of music and/or the segment of the media content item including the piece of music. In some implementations, such information can include a link (e.g., a URL) to a Web site that provides information relating to the music items, a link to a platform via which a user can play, share, purchase, and/or take any other suitable action on one or more of the music items (e.g., a video hosting service, a social networking service, a media player service, an electronic commerce service, and/or any other suitable platform), and/or any other suitable information relating to the music items. In some implementations, a music item can be regarded as being a match to a given segment of the media content item when the music item and the segment contains matching music content (e.g., a song, a piece of music, and/or any other suitable music content performed by the same artist and/or difference artists), matching audio content, matching video content, and/or any other suitable matching content. Additionally or alternatively, the music item and the segment of the media content item can be associated with a matching sentiment (e.g., “happy,” “sad,” “exciting,” “neutral,” and/or any other suitable sentiment). In some implementations, as described below in connection with FIG. 5, a music item that matches a segment of the media content item can be detected using process 500.

At 325, process 300 can present the playlist of music content played in the media content item. In some implementations, information relating to a particular piece of music can be presented using any suitable content in the playlist, such as text, images, video content, audio content, and/or any other suitable content. In some implementations, process 300 can present the playlist to prompt a user to scroll through information about different pieces of music content that are played in the media content item (e.g., text snippets, URLs, thumbnail images, and/or any other suitable information).

In some implementations, the playlist can be presented using any suitable device. For example, the information can be presented on a display coupled to a digital entertainment system (a digital entertainment system 106 of FIG. 1) that is presenting the media content item. Additionally or alternatively, the information can be presented on a mobile device, such as a mobile phone, tablet computer, wearable computer, desktop computer, and/or any other suitable mobile device.

In some implementations, the playlist can be presented responsive to any suitable event. For example, the playlist can be presented when the presentation of the media content has ended. In a more particular example, upon receiving a user's consent and/or authorization to identify the media content item that is currently being presented and/or present a playlist of music content played in the media content item, process 300 can present a playlist of music content played in the media content item upon determining that the media content item has ended.

As another example, the playlist can be presented in response to receiving a search query for music content relating to the media content item. In a more particular example, the search query can include one or more search terms relating to the media content item (e.g., a title of the media content item) and one or more search terms indicative of a user's desire to search for music content relating to the media content (e.g., “music,” “soundtrack,” and/or any other suitable search term indicative of such a desire).

In some implementations, at 330, process 300 can receive a user selection of a piece of music played in the media content item. In some implementations, the piece of music can be selected responsive to a user selection of any suitable portion or portions of the playlist that correspond to the music item, such as a text snippet of the piece of music, an image representative of the piece of music, a link to information about the piece of music and/or music items relating to the piece of music, and/or any other suitable portion of the playlist corresponding to the piece of music.

At 335, process 300 can present information relating to music items that are associated with the piece of music and/or a segment of the media content item in which the piece of music is played. In some implementations, process 300 can present any suitable information relating to the music items, such as descriptions, titles, artists, formats in which the music items are available, one or more platforms via which the music items are available (e.g., a video hosting service, an electronic commerce platform, a social networking platform, and/or any other suitable platform), and/or any other suitable information relating to the music items.

In some implementations, the information relating to the music items can be presented in any suitable manner. For example, process 300 can cause a Web page including such information to be presented using a Web browser, a mobile application, and/or any other suitable application that can render Web content. As another example, process 300 can receive such information from a storage device, server, and/or any other suitable device can present the information using any suitable content, such as video content, audio content, text, and/or any other suitable content.

Turning to FIG. 4, a flow chart of an example 400 of a process for generating a playlist of music content relating to a media content item is shown in accordance with some implementations of the disclosed subject matter. In some implementations, process 400 can be implemented using one or more hardware processors, such as a processor of a server 102 of FIG. 1.

As illustrated, process 400 can begin by receiving an audio sample corresponding to a media content item at 405. The audio sample can be generated and/or received in any suitable manner. For example, the audio sample can be generated using an audio input device (e.g., step 310 of FIG. 3) and can be transmitted to one or more hardware processors executing process 400.

At 410, process 400 can generate an audio fingerprint of the audio sample. The audio fingerprint can include any suitable digital representation of one or more suitable audio features of the audio sample, where the audio fingerprint can be used to identify the same or similar portions of audio data. In some implementations, the audio fingerprint can be generated using any suitable audio fingerprinting algorithms, such as two-dimensional transforms (e.g., a discrete cosine transform), three-dimensional transforms (e.g., a wavelet transform), hash functions, etc. In a more particular example, one or more features of the audio sample (e.g., peaks, amplitudes, power levels, frequencies, signal to noise ratios, and/or any other suitable feature) can be generated for one or more suitable portions of the audio sample. The features can then be processed to form one or more audio fingerprints (e.g., using a hash function).

In some implementations, as described above in connection with FIG. 3, the audio fingerprint can be generated by one or more hardware processors executing process 300 and can be transmitted to a server and/or any other suitable device for analysis.

At 415, process 400 can identify the media content item based on the audio fingerprint of the audio sample. In some implementations, process 400 can access a database that indexes and stores reference audio fingerprints by media content item and can search for a reference audio fingerprint that matches the audio fingerprint of the audio sample. Process 400 can then identify a media content item associated with the matching reference audio fingerprint as being the media content item corresponding to the audio sample. In some implementations, the generated audio fingerprint can be compared against the stored reference audio fingerprints to find a match. In some implementations, a reference audio fingerprint can be regarded as being a match to the audio fingerprint of the audio sample when a difference between the reference audio fingerprint and the audio fingerprint of the audio sample is not greater than a predetermined threshold.

While the disclosed subject matter generally relates to identifying media content using audio fingerprinting and/or matching technique, this is merely illustrative. In some implementations, process 400 can receive a screenshot of the media content item being presented on a display and can identify the media content item using any suitable video fingerprinting and/or matching technique. In some implementations, process 400 can receive program information relating to the media content item, such as a channel number, program title, series number, episode number, URI, and/or any other suitable program information. Process 400 can then identify the media content item based on the received program information.

In some implementations, the mechanisms described herein can, for example, include capture modules that can receive and process signals from multiple sources (e.g., television channels, channels on a video hosting Web site, and/or any other suitable sources of media content). These capture modules can, for each source of media content, capture video screenshots at particular time intervals (e.g., every two or three seconds) and/or generate audio fingerprints from audio data at particular time intervals. In some implementations, these capture modules can monitor media content from multiple content sources and generate video screenshots, audio fingerprints, video fingerprints, transcripts (e.g., captioning content) and/or any other suitable content identifier. More particularly, these capture modules can store the generated video screenshots, audio fingerprints, video fingerprints, transcripts (e.g., captioning content), and other content identifiers in a storage device. For example, a capture module can monitor channels providing broadcast television content and store generated audio fingerprints in a database that is indexed by program and time.

At 420, process 400 can obtain an audio signal associated with the media content item. For example, process 400 can extract an audio signal from the media content item using any suitable audio and/or video processing technique. Additionally, the audio signal can be downsampled, transcoded, filtered, and/or processed using any suitable audio processing technique.

In some implementations, the audio signal can correspond to any suitable portion or portions of the media content item. For example, the audio signal can correspond to one or more video scenes, opening credits, closing credits, montages of footages, commercial breaks, and/or any other suitable portion of the media content item.

At 425, process 400 can identify one or more segments of the audio signal that include music content. In some implementations, the segments of the audio signal can be identified in any suitable manner. For example, process 400 can divide the audio signal into multiple segments using any suitable audio segmentation technique or techniques and can extract one or more features from each of the segments (e.g., an average zero-crossing rate, a fundamental frequency, a root mean square of a set of amplitudes, and/or any other suitable feature). Process 400 can then classify each of the segments into one or more classes based on the extracted features. For example, a particular segment of the audio signal can be classified as “silence,” “speech,” “music,” “song,” “speech with music background,” “noise,” and/or any other suitable class. In some implementations, the segments of the audio signal can be classified using any suitable audio classification technique or combination of techniques, such as a Hidden Markov Model, a Bayesian classifier, the Viterbi algorithm, the Baum-Welch algorithm, and/or any other suitable classification model.

In some implementations, any suitable segment of the audio signal can be regarded as including music content. For example, a segment of the audio signal can be regarded as including music content when the segment is classified as “music,” “song,” “speech with music background,” and/or any other suitable class that can be regarded as corresponding to audio segments that include music content.

At 430, process 400 can identify the music content included in each of the audio segments that are identified at 425. In some implementations, the music content included in a given audio segment (e.g., a piece of instrumental music, a song, a piece of background music, and/or any other suitable music content) can be identified using any suitable information, such as a title, a content identifier, an artist, and/or any other suitable information that can be used to identify the music content.

In some implementations, the music content included in a given audio segment can be identified using any suitable technique or combination of techniques. For example, the music content can be identified using any suitable audio fingerprinting and/or matching technique. In a more particular example, an audio fingerprint representing one or more audio features of the audio segment can be compared against reference audio fingerprints that are stored and indexed by music item. The music content can then be identified by identifying a music item associated with a reference audio fingerprint that matches the audio fingerprint of the audio segment.

As another example, the music content can be identified by comparing a transcript (e.g., captioning content) associated with the audio segment against lyrics associated with a collection of music items. In some implementations, upon detecting lyrics that match the transcript associated with the audio segment, process 400 can identify a music item associated with the matching lyrics as being the music content included in the audio segment.

In some implementations, at 435, process 400 can identify one or more music segments of the media content item. In some implementations, the music segment can include any suitable portion of the media content item that includes music content (e.g., a piece of instrumental music, a song, a piece of background music, and/or any other suitable music content).

In some implementations, the music segments can be identified in any suitable manner. For example, a music segment of the media content item can be identified by locating a portion of the media content item corresponding to a segment of the audio signal that includes music content. In a more particular example, for a particular audio segment identified at 425, process 400 can retrieve a start timestamp corresponding to the start of the audio segment and an end timestamp corresponding to the end of the audio segment. Process 400 can then identify a portion of the media content item defined by the start timestamp and the end timestamp (e.g., a video segment defined by a first frame associated with a presentation timestamp corresponding to the start timestamp and a second video frame associated with a presentation timestamp corresponding to the end timestamp).

At 440, process 400 can search for music items that match the music segments of the media content item. In some implementations, any suitable music item can be regarded as being a match to a given music segment of the media content item. For example, a given music segment of the media content item and a music item that matches the music segment can include matching audio content. In a more particular example, a matching music item can be a soundtrack of a portion of the media content item corresponding to the music segment, a music video including audio content associated with the music segment, a video clip including one or more video scenes extracted from the portion of the media content item corresponding to the music segment, and/or any other suitable music item.

As another example, a given music segment of the media content item and a music item that matches the music segment can include matching music content. In a more particular example, the music segment and the music item can include audio content and/or video content of a piece of music (e.g., a song) that is performed by the same artist or different artists.

As yet another example, a given music segment of the media content item and a music item can be associated with matching sentiments. In some implementations, a sentiment associated with a music segment of a media content item or a music item can be measured by one or more emotions conveyed by the music segment or music item, such as “happy,” “sad,” “exciting,” “neutral,” and/or any other suitable emotion. Additionally or alternatively, such a sentiment can be classified into one of various sentimental states, such as “positive,” “negative,” “neutral,” and/or any other suitable sentimental state.

In some implementations, the matching music items can be identified using any suitable technique or combination of techniques, such as video matching, audio matching, lyrics matching, sentiment matching, and/or any other suitable technique that can be used to analyze the similarity between a portion of a media content item and a music item. In a more particular example, as described below in connection with FIG. 5, the similarity between a music item and a music segment of the media content item can be analyzed based on various measures. In some implementations, the measures can include a video similarity score representative of the similarity between video content associated with the music segment and video content associated with the music item. In some implementations, the measures can include an audio similarity score representative of the similarity between audio content associated with the music segment and audio content associated with the music item. In some implementations, the measures can include a music similarity score representative of the similarity between the music content (e.g., a piece of instrumental music, a particular song, and/or any other suitable music content) contained in the music segment and music content contained in the music item. In some implementations, the measures can include a sentiment score representative of the similarity between sentiments conveyed by the music segment and sentiments conveyed by the music item.

At 445, process 400 can associate the music items with the media content item. In some implementations, any suitable information relating to the music items can be associated with the media content. For example, information relating to a particular music item can include a description, a title, an artist, one or more formats in which the music item is available, one or more platforms via which the music item is available (e.g., a video hosting service, an electronic commerce platform, a social networking platform, and/or any other suitable platform), a link to a Web site that provides information relating to the music item (e.g., a Web site that provides information for playing, sharing, and/or purchasing the music item), and/or any other suitable information relating to the music item.

In some implementations, information relating to a music item can be associated with any suitable information relating to a music segment of the media content item that corresponds to the music item, such as a start time and/or an end time in the media content item corresponding to the music segment, information relating to music content contained in the music segment (e.g., a title, an artist, and/or any other suitable information relating to a piece of instrumental music, a song and/or any other suitable music content contained in the music segment), and/or any other suitable information relating to the music segment. In some implementations, information relating to a music item can be associated with any suitable information relating to the media content, such as a content identifier (e.g., a program identifier, a URI, and/or any other suitable identifier), a description, a link (e.g., a URL) to a Web site that provides information relating to the media content item, and/or any other suitable information relating to the media content item.

In some implementations, the information relating to the music items can be stored and indexed by media content item and/or music segment in a database. In some implementations, process 400 can store the information relating to the music items along with information relating to the media content item and/or music segments of the media content item at particular time intervals (e.g., every N milliseconds) in a database while the media content item is being broadcasted by a television provider or any other suitable content provider.

In some implementations, in response to receiving a subsequent search query for music content relating to a media content item, the mechanisms described herein can identify music items relating to the media content item and retrieve stored information relating to the music items for presentation. In some implementations, in response to receiving a subsequent search query for media content items relating to a particular music item, the mechanisms described herein can identify media content items relating to the music item and retrieve stored information relating to the media content items for presentation.

At 450, process 400 can generate a playlist of music content played in the media content item. In some implementations, the playlist can be generated by compiling any suitable information relating to one or more music segments of the media content item. In some implementations, the playlist can include a start time and/or an end time in the media content item corresponding to the music segment, information relating to music content contained in the music segment (e.g., a title, an artist, and/or any other suitable information relating to a piece of music, a song and/or any other suitable music content contained in the music segment), and/or any other suitable information relating to each of the music segments.

In some implementations, the playlist can include any suitable information relating to one or more music items associated with each of the music segments, such as a link (e.g., a URL) to a Web site that provides information relating to the music items, a link to a platform via which a user can play, share, purchase, and/or take any other suitable action on one or more of the music items (e.g., a video hosting service, a social networking service, a media player service, an electronic commerce service, and/or any other suitable platform), and/or any other suitable information relating to the music items.

Turning to FIG. 5, a flow chart of an example 500 of a process for identifying a music item that matches a portion of a media content item is shown in accordance with some implementations of the disclosed subject matter. In some implementations, one or more portions of process 500 can be implemented by one or more hardware processors, such as one or more hardware processors of a server 102 of FIG. 1.

As illustrated, process 500 can begin by identifying a music segment of a media content item at 505. In some implementations, the music segment can include any suitable portion of the media content item that includes music content (e.g., a piece of instrumental music, a song, a piece of background music, and/or any other suitable music content). In some implementations, the music segment can be identified in any suitable manner. For example, as described in connection with FIG. 4, the music segment can be identified using any suitable audio segmentation and/or classification technique (e.g., steps 420-435 of FIG. 4).

At 510, process 500 can generate an audio fingerprint of the music segment. The audio fingerprint can include any suitable digital representation of one or more suitable audio features of segment of the music segment, where the audio fingerprint can be used to identify the same or similar portions of audio data. In some implementations, the audio fingerprint can be generated using any suitable audio fingerprinting algorithms.

At 515, process 500 can generate a transcript of the music segment. The transcript can be generated in any suitable manner. For example, a transcript associated with the music segment can be generated based on captioning content associated with the music segment (e.g., closed captioning content, subtitles, and/or any other suitable captioning content). As another example, a transcript associated with the music segment can be obtained by transcribing audio content associated with the music segment. In a more particular example, the transcript can be generated by extracting audio content from a portion of the media content item corresponding to the music segment, processing the audio content (e.g., by segmenting, transcoding, and/or filtering the audio content), converting the processed audio content to text using a suitable speech recognition technique, and generating a transcript based on the text.

At 520, process 500 can generate a video fingerprint of the music segment. The video fingerprint can be generated using any suitable video fingerprinting technique. For example, the video fingerprint can be generated by extracting a representative frame from the segment (e.g., a key frame). As another example, the video fingerprint can be generated by calculating one or more spatial characteristics (e.g., one or more vectors corresponding to intensity variations, edge differences, and/or any other suitable intra-frame features), temporal characteristics (e.g., motion vectors, motion trajectories, and/or any other suitable inter-frame features), spatiotemporal characteristics (e.g., by performing a wavelet transformation on a group of video frames), and/or other suitable characteristics of the music segment.

At 525, process 500 can associate the music segment with a sentiment indicator. In some implementations, the sentiment indicator can include one or more emotions conveyed by the music segment, such as “happy,” “sad,” “exciting,” “neutral,” and/or any other suitable emotion. In some implementations, the sentiment indicator can include a sentimental state, such as “positive,” “negative,” “neutral,” and/or any other suitable sentimental state.

In some implementations, the sentiment indicator can be determined by performing any suitable sentiment analysis on the music segment. For example, process 500 can analyze the melody and/or the lyrics of the music content contained in the music segment, the transcript associated with the music segment, metadata associated with the media content item (e.g., a title, description, user rating, user comment, genre, and/or any other suitable metadata) and/or any other suitable information relating to the music segment using natural language processing, text analytics, machine learning, and/or any other suitable technique. Process 500 can then classify the music segment with one or more of a variety of sentiments.

At 530, process 500 can calculate a similarity score between the music segment and each of a collection of music items. In some implementations, process 500 can access to and/or retrieve information relating to the collection of the music items (e.g., audio fingerprints, video fingerprints, lyrics, sentiment indicators, and/or any other suitable information relating to music items) from a database that stores and indexes such information by music item.

In some implementations, a similarity score between the music segment of the media content item and a given music item can be calculated based on any suitable criterion or criteria and/or using any suitable similarity metric or metrics (e.g., a distance metric). For example, a video similarity score can be calculated based on the similarity between video content associated with the music segment and video content associated with the music item. In a more particular example, the video similarity score can be calculated by comparing the video fingerprint associated with the music segment and a video fingerprint associated with the music item and/or calculating a difference between the audio fingerprints.

As another example, an audio similarity score can be calculated based on the similarity between audio content associated with the music segment and audio content associated with the music item. In a more particular example, the audio similarity score can be calculated by comparing the audio fingerprint associated with the music segment and an audio fingerprint associated with the music item and/or calculating a difference between the video fingerprints.

As yet another example, a music similarity score can be calculated based on the similarity between the music content contained in the music segment (e.g., a particular song) and music content contained in the music item. In a more particular example, the music similarity score can be calculated by comparing the transcript associated with the music segment with lyrics associated with the music item.

As still another example, a sentiment similarity score can be calculated based on similarity between sentiments conveyed by the music segment and sentiments conveyed by the music item. In a more particular example, the sentiment similarity score can be calculated by comparing the sentiment indicator associated with the music segment and a sentiment indicator and/or any other suitable sentiment information associated with the music item.

In some implementations, the similarity between the music segment and the music item can be analyzed and a similarity score can be generated by combining the video similarity score, the audio similarity score, the music similarity score, and/or the sentiment similarity score using any suitable technique. For example, the sentiment similarity score can be a multiplier for the music similarity score, the audio similarity score, and/or the video similarity score. As another example, the similarity score can be a weighted sum, a weighted average, and/or any other suitable combination of the video similarity score, the audio similarity score, the music similarity score, and/or the sentiment similarity score.

At 535, process 500 can identify one or more music items that match the music segment. The music items can be identified in any suitable manner. For example, process 500 can rank the collection of music items and/or a subset of the music items and identify one or more of the music items as being matching music items by ranking. In some implementations, the ranking can be performed based on any suitable criterion or criteria, such as by similarity score (e.g., based on one or more of a video similarity score, an audio similarity score, a music similarity score, and/or a sentiment similarity), by popularity (e.g., based on click-through-rates, customer reviews and/or ratings, the number of times that a music item has been shared on one or more social media platforms, and/or any other suitable indication of the popularity of a music item), by source (e.g., whether a content provider that provides a music item has subscribed to services provided by process 500), and/or any other suitable criterion.

In some implementations, any suitable number of music items can be selected as music items that match the music segment based on the ranking. For example, process 500 can select a predetermined number of music items that are associated with particular ranking (e.g., the top 5 music items). As another example, process 500 can select a predetermined percentage of the music items based on the determined ranking.

It should be noted that the above steps of the flow diagrams of FIGS. 3-5 can be executed or performed in any order or sequence not limited to the order and sequence shown and described in the figures. Also, some of the above steps of the flow diagrams of FIGS. 3-5 can be executed or performed substantially simultaneously where appropriate or in parallel to reduce latency and processing times. Furthermore, it should be noted that FIGS. 3-5 are provided as examples only. At least some of the steps shown in these figures may be performed in a different order than represented, performed concurrently, or altogether omitted.

In situations in which the mechanisms discussed here collect personal information about users, or may make use of personal information, the users may be provided with an opportunity to control whether programs or features collect user information (e.g., information about a user's social network, social actions or activities, profession, a user's preferences, or a user's current location), and/or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Accordingly, methods, systems, and media for presenting music items relating to media content are provided.

Although the disclosed subject matter has been described and illustrated in the foregoing illustrative implementations, it is understood that the present disclosure has been made only by way of example, and that numerous changes in the details of implementation of the disclosed subject matter can be made without departing from the spirit and scope of the disclosed subject matter, which is limited only by the claims that follow. Features of the disclosed implementations can be combined and rearranged in various ways.

What is claimed is:

1. A method for presenting music items associated with a media content item, the method comprising:
detecting a plurality of music segments of the media content item that include music content;
identifying a plurality of pieces of music played in the plurality of music segments;
generating, using a hardware processor, a playlist including information relating to the plurality of pieces of music;
causing the playlist to be presented to a user;
receiving a user selection of a portion of the playlist corresponding to a piece of music played in a first music segment of the plurality of music segments; and
causing information relating to a plurality music items that match the first music segment to be presented in response to receiving the user selection.

2. The method of claim 1, further comprising:
generating a transcript of the first music segment; and
identifying a first music item that matches the first music segment based at least in part on the transcript, wherein the plurality of music items that match the first music segment include the first music item.

3. The method of claim 2, further comprising:
associating a sentiment indicator with the first music segment; and
identifying the first music item that matches the first music segment based at least in part on the sentiment indicator.

4. The method of claim 1, further comprising:
generating an audio fingerprint of the first music segment; and
identifying a second music item that matches the first music segment based at least in part on the audio fingerprint, wherein the plurality of music items that match the first music segment include the second music item.

5. The method of claim 4, further comprising:
generating a video fingerprint of the first music segment; and
identifying a third music item that matches the first music segment based at least in part on the video fingerprint, wherein the plurality of music items that match the first music segment include the third music item.

6. The method of claim 1, further comprising:
receiving an audio sample corresponding to the media content item;
generating an audio fingerprint of the audio sample; and
identifying the media content item based on the audio fingerprint.

7. The method of claim 1, further comprising:
causing the media content item to be presented on a display; and
causing the playlist to be presented in response to detecting that the presentation of the media content has ended.

8. The method of claim 1, further comprising:
receiving a search query for music content relating to the media content item; and
causing the playlist to be presented in response to receiving the search query.

9. A system for presenting music items associated with a media content item, the system comprising:
at least one hardware processor that is configured to:
detect a plurality of music segments of the media content item that include music content;
identify a plurality of pieces of music played in the plurality of music segments;
generate a playlist including information relating to the plurality of pieces of music;
cause the playlist to be presented to a user;
receive a user selection of a portion of the playlist corresponding to a piece of music played in a first music segment of the plurality of music segments; and
cause information relating to a plurality music items that match the first music segment to be presented in response to receiving the user selection.

10. The system of claim 9, wherein the hardware processor is further configured to:
generate a transcript of the first music segment; and
identify a first music item that matches the first music segment based at least in part on the transcript, wherein the plurality of music items that match the first music segment include the first music item.

11. The system of claim 10, wherein the hardware processor is further configured to:
associate a sentiment indicator with the first music segment; and
identify the first music item that matches the first music segment based at least in part on the sentiment indicator.

12. The system of claim 9, wherein the hardware processor is further configured to:
generate an audio fingerprint of the first music segment; and
identify a second music item that matches the first music segment based at least in part on the audio fingerprint, wherein the plurality of music items that match the first music segment include the second music item.

13. The system of claim 12, wherein the hardware processor is further configured to:
generate a video fingerprint of the first music segment; and
identify a third music item that matches the first music segment based at least in part on the video fingerprint, wherein the plurality of music items that match the first music segment include the third music item.

14. The system of claim 9, wherein the hardware processor is further configured to:
receive an audio sample corresponding to the media content item;
generate an audio fingerprint of the audio sample; and
identify the media content item based on the audio fingerprint.

15. The system of claim 9, wherein the hardware processor is further configured to:
cause the media content item to be presented on a display; and
cause the playlist to be presented in response to detecting that the presentation of the media content has ended.

16. The system of claim 9, wherein the hardware processor is further configured to:
receive a search query for music content relating to the media content item; and
cause the playlist to be presented in response to receiving the search query.

17. A non-transitory computer-readable medium containing computer executable instructions that, when executed by a processor, cause the processor to perform a method for presenting music items associated with a media content item, the method comprising:
detecting a plurality of music segments of the media content item that include music content;
identifying a plurality of pieces of music played in the plurality of music segments;
generating a playlist including information relating to the plurality of pieces of music;
causing the playlist to be presented to a user;
receiving a user selection of a portion of the playlist corresponding to a piece of music played in a first music segment of the plurality of music segments; and
causing information relating to a plurality music items that match the first music segment to be presented in response to receiving the user selection.

18. The non-transitory computer-readable medium of claim 17, wherein the method further comprises:
generating a transcript of the first music segment; and
identifying a first music item that matches the first music segment based at least in part on the transcript, wherein the plurality of music items that match the first music segment include the first music item.

19. The non-transitory computer-readable medium of claim 18, wherein the method further comprises:
associating a sentiment indicator with the first music segment; and
identifying the first music item that matches the first music segment based at least in part on the sentiment indicator.

20. The non-transitory computer-readable medium of claim 17, wherein the method further comprises:
generating an audio fingerprint of the first music segment; and
identifying a second music item that matches the first music segment based at least in part on the audio fingerprint, wherein the plurality of music items that match the first music segment include the second music item.

21. The non-transitory computer-readable medium of claim 20, wherein the method further comprises:
generating a video fingerprint of the first music segment; and
identifying a third music item that matches the first music segment based at least in part on the video fingerprint, wherein the plurality of music items that match the first music segment include the third music item.

22. The non-transitory computer-readable medium of claim 17, wherein the method further comprises:
receiving an audio sample corresponding to the media content item;
generating an audio fingerprint of the audio sample; and
identifying the media content item based on the audio fingerprint.

23. The non-transitory computer-readable medium of claim 17, wherein the method further comprises:
causing the media content item to be presented on a display; and
causing the playlist to be presented in response to detecting that the presentation of the media content has ended.

24. The non-transitory computer-readable medium of claim 17, wherein the method further comprises:
receiving a search query for music content relating to the media content item; and
causing the playlist to be presented in response to receiving the search query.
